(19) United States
(12) Patent Application Publication
(10) Pub. No.: US 2009/0289934 A1
(43) Pub. Date: Nov. 26, 2009

(54) Method of driving display device, and display device

(75) Inventors: Hitoshi Hirakawa, Kobe (JP); Manabu Ishimoto, Kobe (JP); Kenji Awamoto, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CO., LTD., Hyogo (JP)

(21) Appl. No.: 12/461,080

(22) Filed: Jul. 30, 2009

Related U.S. Application Data
(63) Continuation of application No. PCT/JP2007/051717, filed on Feb. 1, 2007.

(51) Int. Cl. G06F 3/038

(52) U.S. Cl. 345/213; 345/60

(57) ABSTRACT

A method of driving a display device of a plasma tube array type includes: applying, in a first address period, a scan pulse sequentially to display electrodes, each being one display electrode of each display electrode pair in a first group of display electrode pairs; applying, thereafter, a first supplemental pulse of a same polarity as that of the scan pulse to other display electrodes, each being the other display electrode of each display electrode pair in the first group of display electrode pairs, while applying a second supplemental pulse of a polarity opposite to that of the first supplemental pulse, to address electrodes; and applying, thereafter in the first address period before a second address period, a third supplemental pulse of a polarity opposite to that of the first supplemental pulse to the other display electrode of each display electrode pair in the first group of display electrode pairs.

This application is a continuation application of international application PCT/JP2007/51717, filed on Feb. 1, 2007.

### FIELD

The present invention relates generally to driving a display device of a plasma tube array type including elongated, thin gas discharge tubes, and, more particularly, to applying an supplemental pulse for sustaining a priming effect subsequent to address discharge of a plasma tube array.

### BACKGROUND

Japanese Patent Application Publication No. 2003-86141-A (which corresponds to U.S. Pat. No. 6,836,064) describes a proposed display device which includes a plurality of gas discharge tubes disposed adjacent to each other, in each of which gas discharge is generated by applying an electric voltage via external electrodes, and then light is emitted by an internal phosphor.

The proposed display device above includes: such gas discharge tubes, each including a phosphor layer formed therewithin and being filled with discharge gas; two supports which are in contact with the gas discharge tubes and support the gas discharge tubes; and a plurality of electrodes which are disposed on surfaces of the supports that face the gas discharge tubes, such that an external voltage applied via the electrodes to the gas discharge tubes to generate gas discharge in the gas discharge tubes for displaying.

Japanese Patent Application Publication No. HEI 7-191627-A describes a method for driving a plasma display device. According to the driving method, a plasma display panel is divided into a plurality of scan blocks, a short, first sustain discharge period is provided immediately after a write discharge period for each scan block, and a second sustain discharge period is provided for simultaneous discharging in entire display cells is provided after the write discharge for all of the scan blocks. In addition, preliminary discharge erasure, or preliminary discharge and preliminary discharge erasure are provided immediately before the write discharge period for each scan block. This reduces differences among characteristics of the write discharge and of the sustain discharge for respective scan lines, so that an operation margin may be increased.

Japanese Patent Application Publication No. 2006-146217-A (which corresponds to US Patent Application Publication No. 2006/0103597-A) describes a method for driving a plasma display device. According to the driving method, secondary electrodes Y are divided into a plurality of groups including first and second groups. The driving method includes the steps of: selecting cells for displaying in at least one sub-field; alternately applying a second voltage Vs and a third voltage −Vs to the secondary electrodes during a first sustain period, to cause cells for the plurality of groups including at least the first group to generate sustain discharge; and alternately applying a fourth voltage and a fifth voltage to the secondary electrodes during a second sustain period, to cause cells for the plurality of groups including at least the first and second groups to generate sustain discharge. Meanwhile primary electrodes are biased at a predetermined voltage. Thus, a driver board for driving sustain electrodes may be eliminated.

### SUMMARY

According to one aspect of an embodiment of the invention, a method is provided for driving a display device of a plasma tube array type. The display device includes an array of plasma tubes, each plasma tube being filled with discharge gas, a plurality of pairs of display electrodes arranged on a front side of the array of plasma tubes and extending in parallel across the plasma tubes to define a plurality of display lines, and a plurality of address electrodes arranged on a rear side of the array of plasma tubes and extending along a length direction of the plasma tubes. The method includes addressing, in a first address period, a first group of display lines of the plurality of display lines, and addressing, in a second address period, a second group of remaining display lines of the plurality of display lines. In the first address period, a scan pulse is applied sequentially to display electrodes, each being one display electrode of each display electrode pair in a first group of display electrode pairs of the plurality of display electrode pairs, the first group of display electrode pairs corresponding to the first group of display lines. Thereafter in the first address period, a first supplemental pulse of a same polarity as that of the scan pulse is applied to other display electrodes, each being the other display electrode of each display electrode pair in the first group of display electrode pairs, while a second supplemental pulse of a polarity opposite to that of the first supplemental pulse is applied to the plurality of address electrodes. Thereafter in the first address period before the second address period, a third supplemental pulse of a polarity opposite to that of the first supplemental pulse is applied to the other display electrode of each display electrode pair in the first group of display electrode pairs.

An aspect of an embodiment of the invention also relates to a display device including driver circuits, which may implement such a driving method.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of a schematic structure of part of a unit of a conventional array of plasma tubes or gas discharge tubes of a color display device, which may be used for an embodiment of the present invention;

FIG. 2A illustrates an example of a front support plate with a plurality of pairs of transparent display electrodes formed thereon, and FIG. 2B illustrates an example of a rear support plate with a plurality of signal electrodes formed thereon;

FIG. 3 illustrates an example of a cross-section of a structure of an array of plasma tubes (PTA) of a PTA unit in a plane perpendicular to a longitudinal direction;

FIG. 4 illustrates an example of electrical connections of an X-electrode driver unit, a Y-electrode driver unit and an address electrode driver device, of a display device, in accordance with an embodiment of the present invention;

FIG. 5 illustrates an example of a schematic driving sequence of output driving voltage waveforms of the X-electrode driver circuit which does not have an address supplemental circuit, the Y-electrode driver circuit and the address driver circuits, in the display device, in a conventional manner;

FIGS. 6A, 6B and 6C illustrate an example of respective changing states of the wall charges induced over the address electrode, the sustaining electrode and the scanning electrode of a cell, that appear right after the reset discharge, during the subsequent address discharge, and right after the address discharge, respectively, in accordance with the conventional driving sequence of FIG. 5;

FIGS. 7A, 7B and 7C illustrate an example of other respective changing states of wall charges on an address electrode, a sustain electrode and a scan electrode of a cell after a reset discharge, during a subsequent address discharge, and after the address discharge, respectively, in accordance with a conventional driving sequence illustrated in FIG. 5;

FIGS. 8A and 8B illustrate an example of further respective changing states of wall charges on an address electrode, a sustain electrode and a scan electrode of a cell, in which address discharge is unsuccessful, or which has not been addressed, after a reset discharge and after the subsequent address discharge period, respectively, in the conventional driving sequence of FIG. 5;

FIGS. 9A and 9B illustrate an example of an arrangement of the Y-electrode driver device of the display device, in accordance with the embodiment of the present invention;

FIGS. 10A and 10B illustrate an example of an arrangement of the X-electrode driver device for the display device in accordance with the embodiment of the present invention;

FIGS. 11A-11E illustrate an example of a schematic driving sequence of output drive voltage waveforms of the X-electrode driver device, the Y-electrode driver device and the address driver circuit during an address period TA in the display device, in accordance with the embodiment of the present invention;

FIGS. 12A-12E illustrate another example of a schematic driving sequence of output drive voltage waveforms of the X-electrode driver device, the Y-electrode driver device and the address driver circuit during an address period TA in the display device, in accordance with the embodiment of the present invention, and FIG. 12F illustrates address discharges generated by the application of the supplemental pulses;

FIGS. 13A-13D illustrate an example of changing states of wall charges on an address electrode, a sustain electrode and a scan electrode of a cell, after the address discharge which forms an insufficient amount of negative charge on the sustain electrode and an insufficient amount of positive charge on the scan electrode, during the subsequent address supplemental discharge, and after the address supplemental discharge, according to the driving sequence illustrated in FIGS. 11 and 12; and

FIGS. 14A-14D illustrate an example of changing states of wall charges on the address electrode, the sustain electrode and the scan electrode of a cell, after the address discharge which provides a sufficient amount of negative charge on the sustain electrode and a sufficient amount of positive charge on the scan electrode, during the subsequent address supplemental discharge, and after the address supplemental discharge, according to the driving sequence illustrated in FIGS. 11 and 12.

### DESCRIPTION OF THE PREFERRED EMBODIMENTS

Non-limiting preferred embodiments of the present invention will be described with reference to the accompanying drawings. Throughout the drawings, similar symbols and numerals indicate similar items and functions.

A gas discharge tube in a plasma tube array has a diameter of about one (1) mm and hence has a large discharge space and high light-emitting efficiency. However, space charges tend to spread, and wall charges tend to be formed insufficiently. Accordingly, as the time between the generation of address discharge and the beginning of sustain discharge is longer, the priming effect reduces or disappears more, which increases probability of unsuccessful sustain discharge. If the time between an end of reset discharge and the beginning of address discharge, or the time between the address discharge and the sustain discharge is too long, space charges tend to reduce, which tends to cause missing or failure of such sustain discharge.

The inventors have recognized that, application of supplemental pulses to an address electrode and an X display electrode, respectively, for an address-discharged cell during an address period can hold the priming effect of charged particles in a discharge space longer during the rest of the address period, and also can correct or compensate insufficient amounts of wall charges formed by the address discharge to thereby re-form sufficient amounts of wall charges on respective display electrodes.

An object of an embodiment of the invention is to hold a priming effect by address discharge longer in a gas discharge tube of a display device.

Another object of an embodiment of the invention is to repair insufficient wall charge formed by address discharge in gas discharge tubes of a display device to be in a better condition.

According to an embodiment of the invention, a priming effect by address discharge longer can be held in a gas discharge tube of a display device, and wall charge formed by address discharge in gas discharge tubes of a display device reducing to insufficient amount with time can be repaired to be in a better condition.

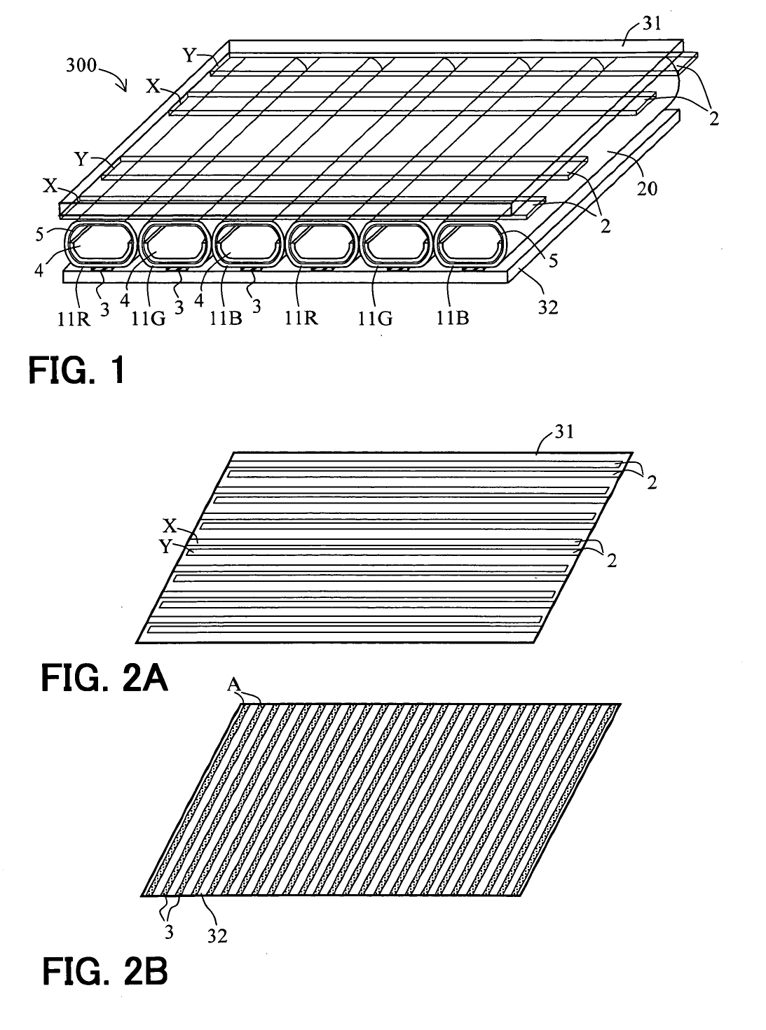

FIG. 1 illustrates an example of a schematic structure of part of a unit 300 of a conventional array of plasma tubes or gas discharge tubes 11R, 11G and 11B of a color display device 10, which may be used for an embodiment of the present invention. In FIG. 1, the unit 300 of the plasma tube array (PTA) includes an array of thin, elongated transparent color plasma tubes 11R, 11G, 11B, . . . , disposed in parallel with each other, a front support plate 31 composed of a transparent front support sheet or thin plate, and a rear support plate 32 composed of a transparent or opaque rear support sheet or thin plate. The PTA unit 300 further includes a plurality of pairs of display or main electrodes 2, and a plurality of signal or address electrodes 3. In FIG. 1, a letter X represents a sustain or X electrode of the display electrodes 2, and a letter Y represents a scan or Y electrode of the display electrodes 2. Letters R, G and B represent red, green and blue, which are colors of light emitted by the phosphors. The front and rear support plates 31 and 32 are made of, for example, flexible or elastic PET or glass films or sheets.

A thin elongated tube 20 for the thin elongated plasma tubes 11R, 11G and 11B is formed of a transparent, insulating material, e.g. borosilicate glass, Pyrex®, soda-lime glass, silica glass, or Zerodur®. The tube 20 may have cross-section dimensions of a tube diameter of 2 mm or smaller, for example flattened-circular or race-track shaped cross section with a 1 mm width and a height somewhat smaller than the width, and a tube length of 300 mm or larger, and a tube wall thickness of about 0.1 mm.

Red, green and blue (R, G, B) phosphor layers 4 may be formed or deposited on the rear sides of inner surfaces of the plasma tubes 11R, 11G and 11B, respectively. Discharge gas is introduced into the interior space of each plasma tube, and the plasma tube is sealed at its opposite ends. An electron emissive film 5 of MgO is formed on the inner surface of the plasma tube 11R, 11G, 11B. The phosphor layers R, G and B may have a thickness within a range of from about 10 μm to about 50 μm. The phosphor layers may be formed according to a known method, such as the precipitation method, in this technical field.

The electron emissive film 5 emits electrons, when it is bombarded with charged particles of the discharge gas. When a voltage is applied between the pair of display electrodes 2, the discharge gas contained in the tube is excited. The phosphor layer 4 is excited by vacuum ultraviolet radiation generated by de-excitation of the excited discharge gas to thereby emit visible light.

FIG. 2A illustrates an example of the front support plate 31 with the plurality of pairs of transparent display electrodes 2 formed thereon. FIG. 2B illustrates the rear support plate 32 with the plurality of signal electrodes 3 formed thereon.

The signal electrodes 3 are formed on the front-side surface, or inner surface, of the rear support plate 32, and extend along the longitudinal direction of the plasma tubes 11R, 11G and 11B. The pitch, between adjacent ones of the signal electrodes 3, is substantially equal to the width of each of the plasma tubes 11R, 11G and 11B, which may be, for example, 1 mm. The pairs of display electrodes 2 are formed on the rear-side surface, or inner surface, of the front support plate 31 in a well-known manner, and are disposed so as to extend perpendicularly to the signal electrodes 3. The width of the display electrode 2 may be, for example, 0.75 mm, and the distance between the edges of the display electrodes 2 in each pair may be, for example, 0.4 mm. A distance providing a non-discharging region, or non-discharging gap, is secured between one display electrode pair 2 and the adjacent display electrode pairs 2, and the distance may be, for example, 1.1 mm.

The signal electrodes 3 and the pairs of display electrodes 2 are brought into intimately contact respectively with the lower and upper peripheral surface portions of the plasma tubes 11R, 11G and 11B, when the display device 10 is assembled. In order to provide better contact, an electrically conductive adhesive may be placed between the display electrodes and the plasma tube surface portions.

In plan view of the PTA unit 300 seen from the front side, the intersections of the signal electrodes 3 and the pairs of display electrodes 2 provide unit light-emitting regions. Display is provided by using either one electrode of each pair of display electrodes 2 as a scan electrode, generating a selection discharge at the intersection of the scan electrode with the signal electrode 3 to thereby select a light-emitting region, and generating a display discharge between the pair of display electrodes 2 using the wall charge formed by the selection discharge on the region of the inner tube surface at the selected region, which, in turn, causes the associated phosphor layer to emit light. The selection discharge is an opposite discharge generated within each plasma tube 11R, 11G, 11B between the vertically opposite scan electrode and signal electrode 3. The display discharge is a surface discharge generated within each plasma tube 11R, 11G and 11B between the two display electrodes of each pair of display electrodes disposed in parallel in a plane.

The pair of display electrodes 2 and the signal electrode 3 can generate discharges in the discharge gas within the tube by applying voltages between them. The electrode structure of the plasma tubes 11R, 11G and 11B illustrated in FIG. 1 is such that the three electrodes are disposed in one light-emitting region, and that the discharge between the pair of display electrodes generates a discharge for display. However, the electrode structure is not limited to such a structure. A display discharge may be generated between the display electrode 2 and the signal electrode 3. In other words, an electrode structure of a type employing a single display electrode may be employed instead of each pair of display electrodes 2, in which the single display electrode 2 is used as a scan electrode so that a selection discharge and a display discharge (opposite discharge) are generated between the single display electrode 2 and the signal electrode 3.

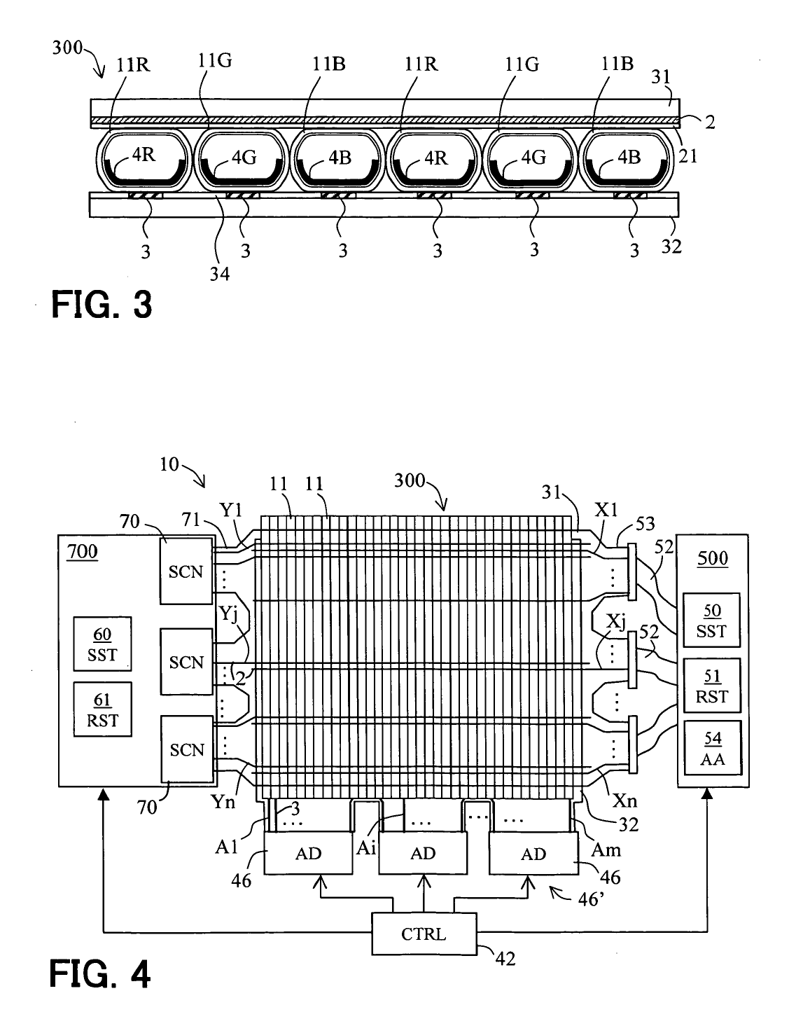

FIG. 3 illustrates an example of a cross-section of the structure of the array of plasma tubes (PTA) 11 of the PTA unit 300 in a plane perpendicular to the longitudinal direction. In the PTA unit 300, phosphor layers 4R, 4G and 4B are formed on the inner surface portions of the plasma tubes 11R, 11G and 11B, respectively. The plasma tubes are thin tubes having a tube thickness of 0.1 mm, a width in the cross-section of 1.0 mm, a height in the cross-section of 0.7 mm, and a length of from 1 m to 3 m. For example, the red-emitting phosphor 4R may be formed of an yttria based material ((Y.Ga)BO₃:Eu), the green-emitting phosphor 4G may be formed of a zinc silicate based material (Zn₂SiO₄:Mn), and the blue-emitting phosphor 4B may be formed of a BAM based material (BaMgAl₁₀O₁₇:Eu).

In FIG. 3, the rear support plate 32 is bonded or fixed to bottom surfaces of the red-emitting plasma tubes 11R, 11G and 11B. The signal electrodes 3R, 3G and 3B are disposed on the bottom surfaces of the plasma tubes 11R, 11G and 11B and on an upper surface of the rear support plate 32. Alternatively, the signal electrodes 3R, 3G and 3B may be disposed directly only on the bottom surfaces of the plasma tubes 11R, 11G and 11B.

FIG. 4 illustrates an example of electrical connections of an X-electrode driver unit 500, a Y-electrode driver unit 700 and an address electrode driver device 46′ which includes address electrode driver circuits 46, of a display device 10, in accordance with an embodiment of the present invention. In the display device 10, the plasma tube array 11 has n pairs of display electrodes 2, (X1, Y1), ((Xj, Yj), . . . , (Xn, Yn). Each pair of display electrodes Xj and Yj may define a display line. Ones of the display electrodes 2 of the pairs of display electrodes 2 are connected from a right end portion 53, divided into plural sections, of the front support plate 31 to a sustain voltage pulse circuit 50 for X-electrodes and an address supplemental circuit (AA) 54 in the X-electrode driver unit 500 through flexible cables 52. In addition, the other ones of the display electrodes 2 of the pairs of display electrodes 2 are connected from a left end portion 71, divided into plural sections, of the front support plate 31 to scan pulse circuits (SCNs) 70 in the Y-electrode driver unit 700. A sustain voltage pulse circuit 60 for the Y-electrodes of the Y-electrode driver unit 700 is connected to the scan pulse circuits (SCNs) 70 through flexible cables. A plurality, m, of signal electrodes 3, A1, . . . , Ai, . . . , Am, are connected to address electrode driver circuits 46 from the lower end divided into plural sections. The X-electrode driver unit 500 includes also a reset circuit 51. The Y-electrode driver unit 700 includes also a reset circuit 61. A driver control circuit 42 is connected to the X-electrode driver circuit 500, the Y-electrode driver circuit 700 and the address electrode driver circuits 46.

Now, an example of a method for driving an AC gas discharge display device of the plasma tube array type is described. One picture may have one frame period. One frame includes two fields in the interlaced scanning scheme, and one frame includes one field in the progressive scanning scheme. For displaying a moving picture in a conventional television system, thirty or sixty frames per second may be displayed. In displaying on the display device 10 of this type of AC gas discharge display device, for reproducing colors by the binary control of light emission, one field F may be divided into or replaced with a set of q subfields SF's. Often, the number of times of discharging for display for each subfield SF is set by weighting these subfields SF's with respective weighting factors of 2⁰, 2¹, 2², . . . , 2^{q-1} in this order. N (=1+2¹+2²+ . . . +2^{q-1}) steps of brightness can be provided for each color of R, G and B in one field by associating light emission or non-emission with each of the subfields in combination. In accordance with such a field structure, a field period Tf, which represents a cycle of transferring field data, is divided into q subfield periods Tsf's, and the subfield periods Tsf's are associated with respective subfields SF's of data. Furthermore, a subfield period Tsf is divided into a reset period TR for initialization, an address period TA for addressing, and a display or sustain period TS for emitting light. The lengths of the reset period TR and the address period TA may be constant independently of the weighting factors for the brightness, while the number of pulses in the display period TS becomes larger as the weighting factor becomes larger, and the length of the display period TS becomes longer as the weighting factor becomes larger. In this case, the length of the subfield period Tsf becomes longer, as the weighting factor of the corresponding subfield SF becomes larger.

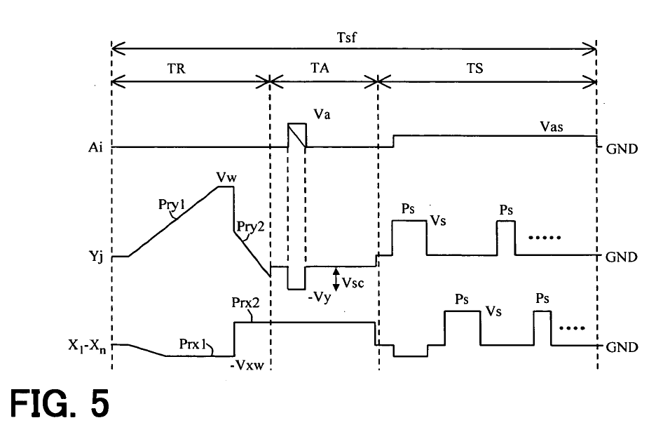

FIG. 5 illustrates an example of a schematic driving sequence of output driving voltage waveforms of the X-electrode driver circuit 500 which does not include the address supplemental circuit 54, the Y-electrode driver circuit 700 and the address driver circuits 42, in the display device 10, in a conventional manner. The waveform illustrated is an example, and the amplitudes, polarities and timings of the waveforms may be varied differently.

The q subfields SF's have the same order of the reset period TR, the address period TA and the sustain period TS in the driving sequence, and this sequence is repeated for each subfield SF. During the reset period TR of each subfield SF, a negative polarity pulse Prx1 and a positive polarity pulse Prx2 are applied in this order to all of the display electrodes X's, and a positive polarity pulse Pry1 and a negative polarity pulse Pry2 are applied in this order to all of the display electrodes Y's. The pulses Prx1, Pry1 and Pry2 have ramping waveforms having the amplitudes which gradually increase at the rates of variation that produce micro-discharge. The first pulses Prx1 and Pry1 are applied to produce, in all of the cells, appropriate wall voltages having the same polarity, regardless of whether the cells have been illuminated or unilluminated during the previous subfield. Subsequently, the second pulses Prx2 and Pry2 are applied to the discharge cells on which an appropriate amount of wall charge is present, which adjusts the wall charge to decrease to a level (blanking state) at which sustain pulses cannot cause re-discharging. The driving voltage applied to the cell is a combined voltage which represents difference between the amplitudes of the pulses applied to the respective display electrodes X and Y.

During the address period TA, wall charges required for sustaining illumination are formed only on the cells to be illuminated. While all of the display electrodes X's and of the display electrodes Y's are biased at the respective desired potentials, a negative scan pulse voltage −Vy is applied to a row of a display electrode Y corresponding to a selected row for each row selection interval (a scan interval for one row of the cells). Simultaneously with this row selection, an address pulse voltage Va is applied only to address electrodes A's which correspond to the selected cells to produce address discharges. Thus, the potentials of the address electrodes A1 to Am are binary-controlled in accordance with the subfield data Dsf for m columns in the selected row j. This causes address discharges to occur in the discharge tubes of the selected cells between the display electrode Y's and the address electrode A's, and the display data written by the address discharges is stored in the form of wall charges on the cell inner walls of the discharge tubes. A sustain pulse applied subsequently causes surface discharges between the display electrodes X's and Y's.

During the sustain period TS, a first sustain pulse Ps is applied so that a polarity of the first sustain pulse Ps (i.e., the positive polarity in the illustrated example) is added to the wall charge produced by the previous address discharge to cause a sustain discharge. Then, the sustain pulse Ps is applied alternately to the display electrodes X's and the display electrodes Y's. The amplitude of the sustain pulse Ps corresponds to the sustain voltage Vs. The application of the sustain pulse Ps produces surface discharge in the discharge cells which have a desired amount of residual wall charge. The number of applied sustain pulses Ps's corresponds to the weighting factor of the subfield SF as described above. In order to prevent undesired opposite discharge between the opposite electrodes during the entire sustain period TS, the address electrodes A's may be biased at a voltage Vas having the same polarity as the sustain pulse Ps.

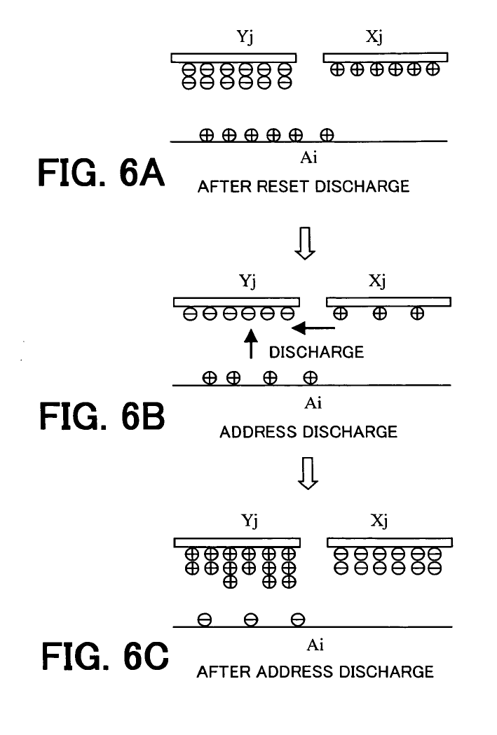

FIGS. 6A, 6B and 6C illustrate an example of respective changing states of the wall charges induced over the address electrode Aᵢ, the sustain electrode Xⱼ and the scanning electrode Yⱼ of a cell, that appear right after the reset discharge, during the subsequent address discharge, and right after the address discharge, respectively, according to the conventional driving sequence of FIG. 5.

During a reset period TR, the applied voltage waveforms and potentials are controlled so that only the scanning electrode Yⱼ is assumed to be an anode and the address electrode Aᵢ and the sustain electrode Xⱼ are assumed to be cathodes. Consequently, as illustrated in FIG. 6A, before the address discharge right after the reset discharge, a negative polarity charge is induced on the Yⱼ electrode, and positive polarity charges are induced on the address electrode Aᵢ and the sustain electrode Xᵢ. As illustrated in FIG. 6B, during the address discharge, surface discharge is produced between the sustain electrode Xⱼ and the scanning electrode Yⱼ, which is triggered by the vertical opposite discharge between the address electrode Aᵢ and the scanning electrode Yⱼ. As illustrated in FIG. 6C, right after the address discharge, a sufficient amount of negative charge is induced on the sustain electrode Xⱼ, and a sufficient amount of positive charge is induced on the scanning electrode Yⱼ, to thereby allow subsequent sustain discharge.

However, as time elapses after the address discharge, a priming effect of space charges within the cell tends to decrease, and wall charges on the electrodes Xj, Yj and Ai tend to decrease.

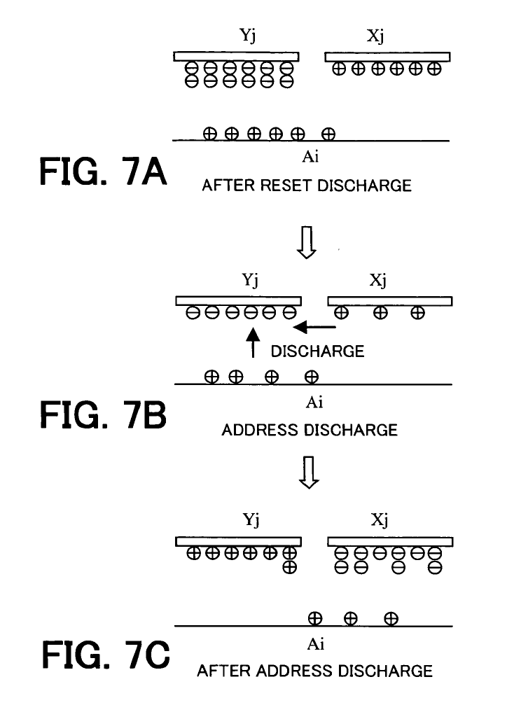

FIGS. 7A, 7B and 7C illustrate an example of other respective changing states of wall charges on an address electrode Ai, a sustain electrode Xj and a scan electrode Yj of a cell after a reset discharge, during a subsequent address discharge and after the address discharge, respectively, according to the conventional driving sequence of FIG. 5.

FIG. 7A is similar to FIG. 6A. FIG. 7B is similar to FIG. 6B. As illustrated in FIG. 7C, after the end of the address discharge, an insufficient amount of negative charge is formed on the sustain electrode Xj, and an insufficient amount of positive charge is formed on the scan electrode Yj, which increases the probability of failure of subsequent sustain discharge.

In addition, as the time lapses after the address discharge, the priming effect of space charges within the cell tend to decrease, and the wall charges on the electrodes Xj, Yj and Ai tend to decrease.

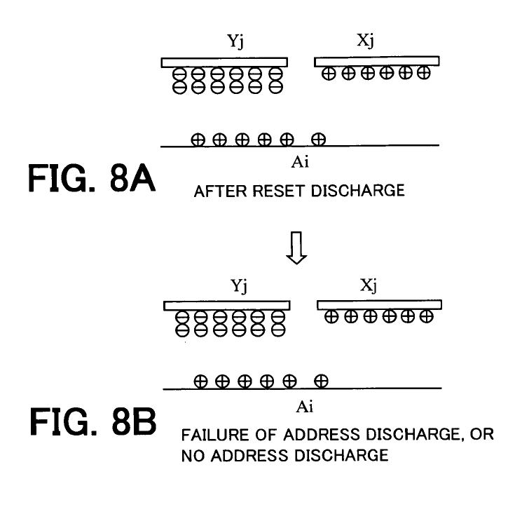

FIGS. 8A and 8B illustrate an example of further respective changing states of wall charges on an address electrode Ai, a sustain electrode Xj and a scan electrode Yj of a cell, in which address discharge is unsuccessful, or which has not been addressed, after a reset discharge and after the subsequent address discharge period, respectively, according to the conventional driving sequence of FIG. 5.

When address discharge is unsuccessful or address discharge does not occur, the state after the reset discharge illustrated in FIG. 8A is maintained, as illustrated in FIG. 8B, so that sustain discharge does not occur.

The inventors have recognized that, application of supplemental pulses to an address electrode Ai and to a sustain electrode Xj, for a cell in which address discharge has occurred during an address period TA can hold the priming effect of charged particles in a discharge space longer during the rest of the address period, and also can correct or compensate insufficient amounts of wall charges formed by the address discharge to thereby re-form sufficient amounts of wall charges on X-electrode and Y-electrode.

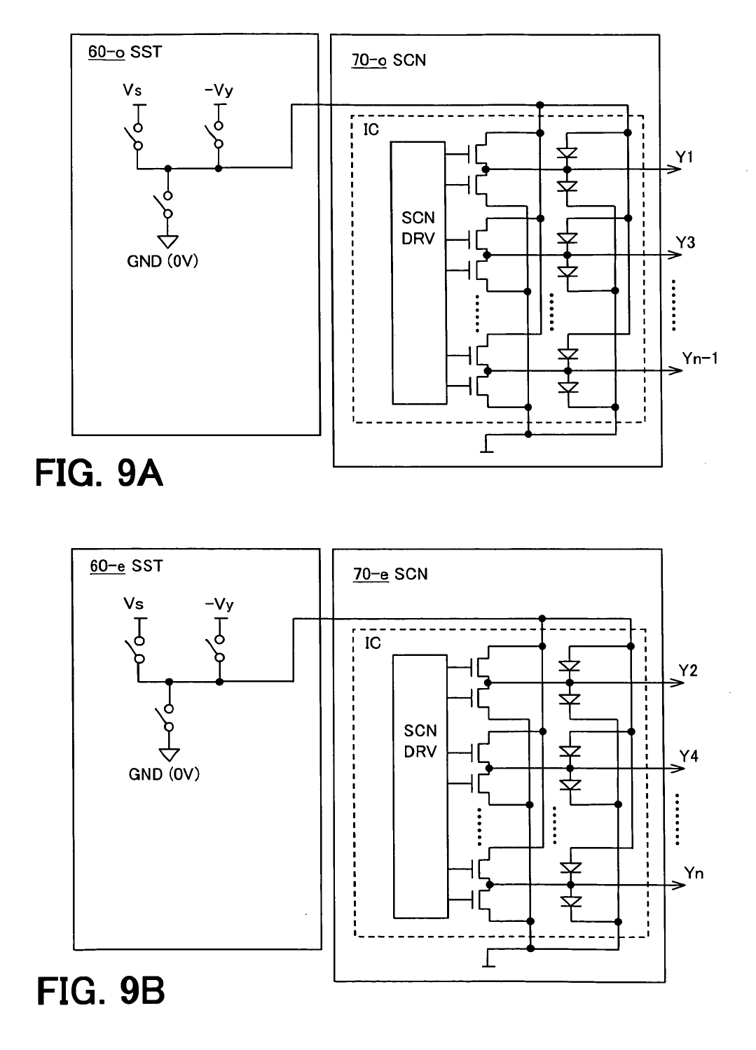

FIGS. 9A and 9B illustrate an example of an arrangement of the Y-electrode driver device 700 of the display device 10, in accordance with the embodiment of the present invention. The Y-electrode driver device 700 includes a sustain voltage pulse circuit (SST) 60-o and a scan pulse circuit (SCN) 70-o for odd-numbered Y-electrode lines as illustrated in FIG. 9A, and a sustain voltage pulse circuit 60-e and a scan pulse circuit (SCN) 70-e for even-numbered Y-electrode lines as illustrated in FIG. 9B. The sustain voltage pulse circuit 60-o couples a sustain DC voltage source Vs, a scan DC voltage source −Vy, and ground potential GND to odd-numbered Y-electrode lines Y1, Y3, . . . , Yn−1 (where n is an even number) through respective associated switches and through the scan pulse circuit 70-o. The sustain voltage pulse circuit 60-e couples the sustain DC voltage source Vs, the scan DC voltage source −Vy, and the ground potential GND to even-numbered Y-electrode lines Y2, Y4, . . . , Yn (where n is an even number) through respective associated switches and through the scan pulse circuit 70-e.

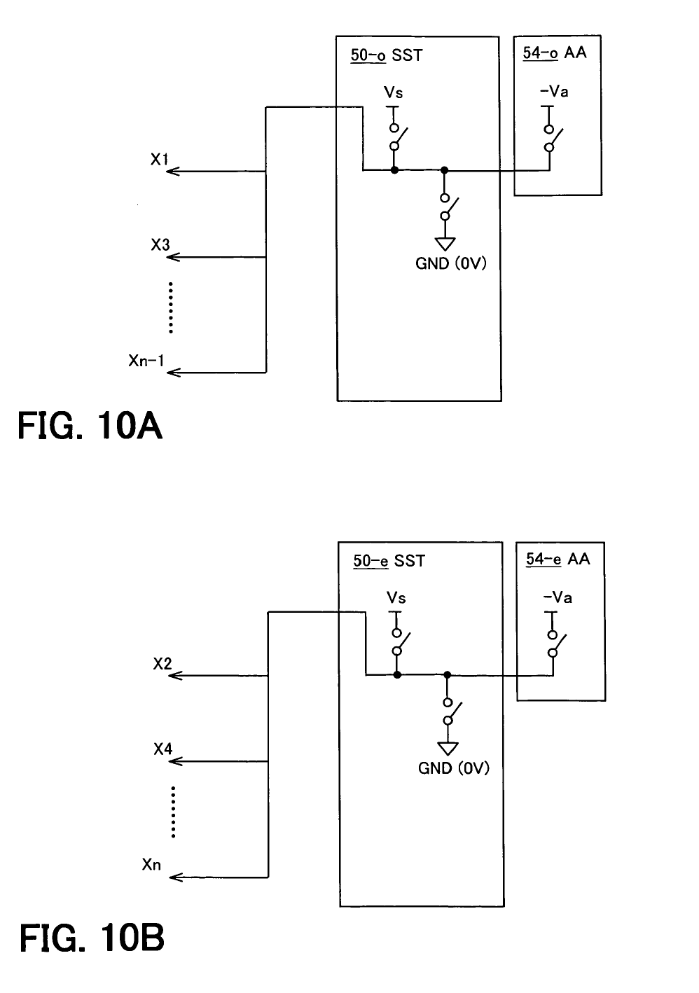

FIGS. 10A and 10B illustrate an example of an arrangement of the X-electrode driver device 500 for the display device 10, in accordance with the embodiment of the present invention. The X-electrode driver device 500 includes a sustain voltage pulse circuit (SST) 50-o and an address supplemental circuit (AA) 54-o for odd-numbered X-electrode lines, and a sustain voltage pulse circuit (SST) 50-e and an address supplemental circuit (AA) 54-e for even-numbered X-electrode lines. The sustain voltage pulse circuit 50-o couples a sustain DC voltage source Vs and ground potential GND through respective switches to odd-numbered X-electrode lines X1, X3, . . . , Xn−1. The sustain voltage pulse circuit 50-e couples the sustain DC voltage source Vs and the ground potential GND through respective switches to even-numbered X-electrode lines X2, X4, . . . , Xn (where n is an even number). The address supplemental circuit 54-o couples a DC voltage source Va through a switch to the odd-numbered X-electrode lines X1, X3, . . . , Xn−1. The address supplemental circuit 54-e couples the DC voltage source Va through a switch to the even-numbered X-electrode lines X2, X4, . . . , Xn.

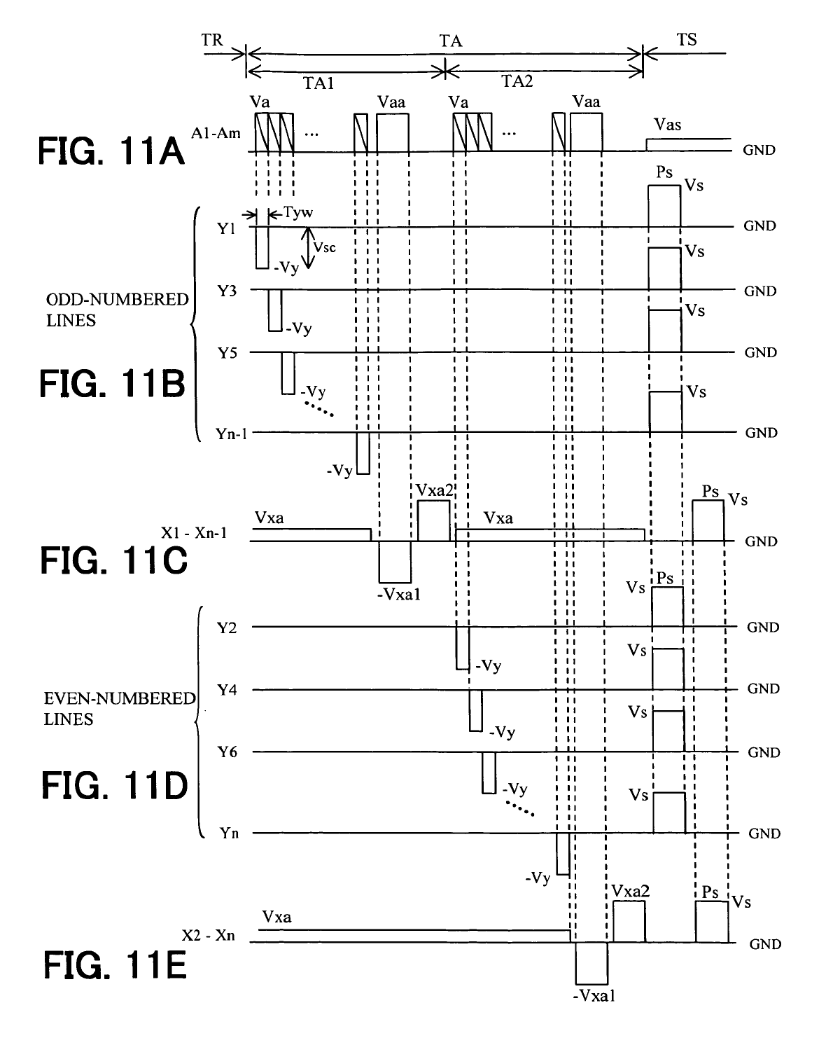

FIGS. 11A-11E illustrate an example of a schematic driving sequence of output drive voltage waveforms of the X-electrode driver device 500, the Y-electrode driver device 700 and the address driver circuit 42 during an address period TA in the display device 10, in accordance with the embodiment of the present invention.

Referring to FIGS. 11A-11E, the address period TA is divided into first and second sub-address periods in this embodiment, and the display electrodes (X1, Y1)-(Xn, Yn) (where n is an even number) are divided into two groups, one being of odd number lines driven during the first sub-address period TA1 and the other being of even number lines driven during the second sub-address period TA2.

During the first sub-address period TA1 of the address period TA, the scan pulse circuit 70-o successively applies the scan voltage pulse −Vy to the Y-electrodes Y1, Y3, Yn−1 of the group of odd-numbered lines, during which the address electrode driver circuits 46 apply the address voltage pulse Va to selected ones of the address electrodes A1-Am. The address voltage pulse Va may have a width of from 1 μs to 2 μs and a height of, for example, 80 V. The scan voltage pulse −Vy may have the same width as the address voltage pulse Va, and may have a height of, for example, −300 V. Thereafter, the address supplemental circuit 54 applies an supplemental pulse −Vxa1 simultaneously to the X-electrodes X1, X3, . . . , Xn−1 of the group of odd-numbered lines, during which the address electrode driver circuits 46 apply an address supplemental pulse Vaa to the address electrodes A1-Am. After that, the address supplemental circuit 54 applies an supplemental pulse Vxa2 simultaneously to the X-electrodes X2, X4, . . . , Xn of the group of even-numbered lines. The address supplemental pulse Vaa may have a width of from 3 μs to 5 μs, which is larger than the width of the address voltage pulse Va and equal to the width of the sustain voltage pulse Vs, and may have a height same as that of the address voltage pulse Va. The supplemental pulse −Vxa1 may have a width same as those of the address supplemental pulse Vaa and the sustain voltage pulse Vs, and may have a height same as the height of the scan voltage pulse −Vy. The supplemental pulse Vxa2 may have a width same as those of the address supplemental pulse Vaa and the sustain voltage pulse Vs, and may have a height same as that of the sustain voltage pulse Vs.

In the second sub-address period TA2 of the address period TA, the scan pulse circuit 70-e applies the scan voltage pulse successively to the Y-electrodes Y2, Y4, . . . , Yn of the group of even-numbered lines, during which the address electrode driver circuits 46 apply a address voltage pulse Va to selected ones of the address electrodes A1-Am. After that, the address supplemental circuit 54 applies the supplemental pulse −Vxa1 to the X-electrodes Y2, Y4, . . . , Yn of the group of even-numbered lines, during which the address electrode driver circuits 46 apply the supplemental pulse Vaa to the address electrodes A1-Am, and, after that, the address supplemental circuit 54 applies the supplemental pulse VXa2 to the X-electrodes Y2, Y4, . . . , Yn of the group of even-numbered lines.

Then, the sustain voltage pulse circuits 50 and 60 apply sustain voltage pulses to the display electrodes (X1, Y1)-(Xn, Yn) during the sustain period TS. The other operations of the X-electrode driver device 500, the Y-electrode driver circuit 700 and the address driver circuit 42 are similar to those of FIG. 5.

During the address period TA, the supplemental pulses −Vxa1 and Vxa2 are applied to the X-electrodes of the cells in which address discharge has occurred, for the respective groups of odd-numbered display electrode lines (X1, Y1)-(Xn−1, Yn−1) and even-numbered display electrode lines (X2, Y2)-(Xn, Yn), and the supplemental pulse Vaa is applied to the address electrodes, which, thereby, enables the priming effect of the charged particles in the discharge space to be maintained longer, and also enables insufficient amounts of wall discharges formed by the address discharge to be corrected to form sufficient amounts of wall charges on the X- and Y-electrodes. In this way, unsuccessful address discharge can be greatly reduced. However, the supplemental pulses −Vxa1, Vxa2 and Vaa may not necessarily be applied during the second sub-address period TA2. This is so because the sustain voltage pulse is applied to the group of even-numbered display electrodes (X2, Y2), (X4, Y4), . . . , (Xn, Yn) right after the address discharge.

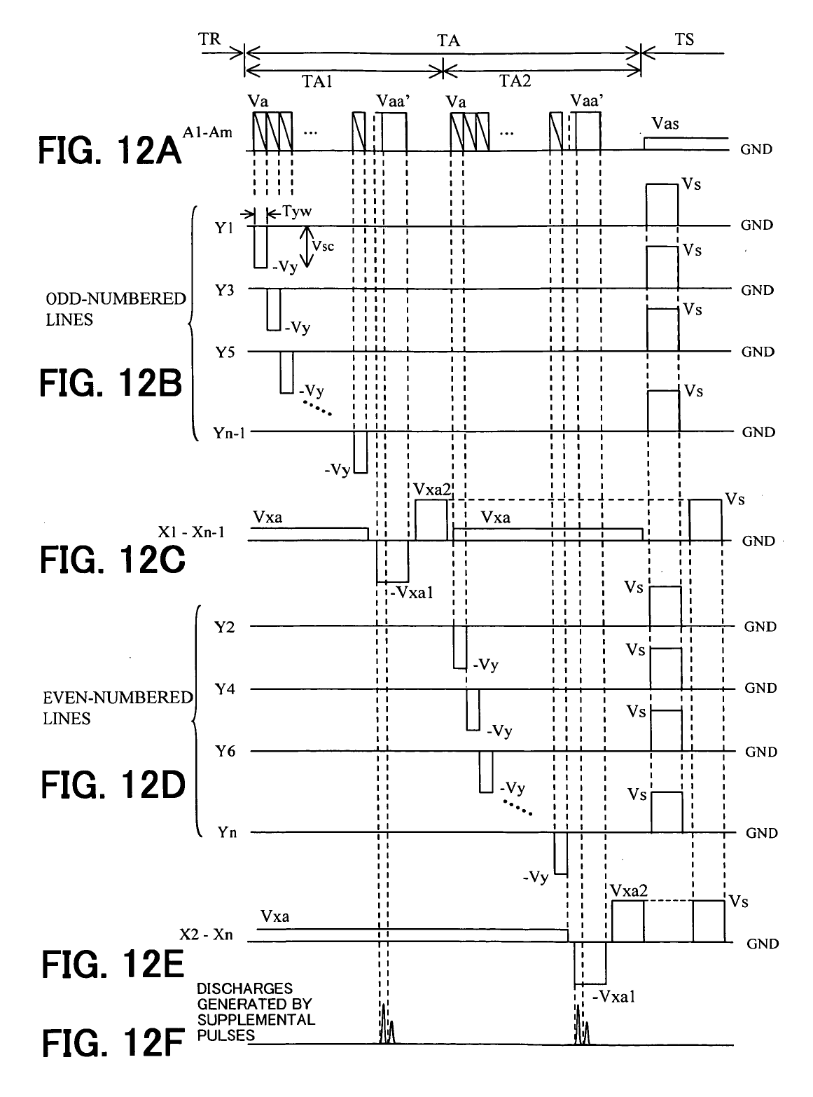

FIGS. 12A-12E illustrate another example of a schematic driving sequence of output drive voltage waveforms of the X-electrode driver device 500, the Y-electrode driver device 700 and the address driver circuit 42 during an address period TA in the display device 10, in accordance with the embodiment of the present invention. FIG. 12F illustrates address discharges generated by the application of the supplemental pulses −Vxa1, Vxa2 and Vaa′.

Referring to FIGS. 12A-12E, during the first sub-address period TA1, the scan voltage pulse is successively applied to the Y-electrodes Y1, Y3, . . . , Yn−1 of the group of odd-numbered lines, during which the address voltage pulse Va is applied to selected ones of the address electrodes A1-Am. After that, the address supplemental circuit 54 applies the supplemental pulse −Vxa1 to the X-electrodes X1, X3, . . . , Xn−1 of the group of odd-numbered lines, during which the address electrode driver circuits 46 apply the supplemental pulse Vaa′ to the address electrodes A1-Am a particular length of time (e.g. 0.5 μs) after the beginning of the application of the supplemental pulse −Vxa1. After the application of the supplemental pulses −Vxa1 and Vaa′, the address supplemental circuit 54 applies the supplemental pulse Vxa2 to the X-electrodes X2, X4, . . . , Xn of the group of even-numbered lines. The address supplemental pulse Vaa′ may have a width of from 2.5 μs to 4.5 μs, which is larger than that of the address voltage pulse Va and smaller by, for example, 0.5 μs than that of the sustain voltage pulse Vs, and may have the same height as the address voltage pulse Va. The supplemental pulse −Vxa1 may have a width larger than the width of the address supplemental pulse Vaa′ and same as the width of the sustain voltage pulse Vs, and may have the same height as the scan voltage pulse −Vy. The supplemental pulse Vxa2 may have the same width and height as the sustain voltage pulse Vs.

In the second sub-address period TA2 of the address period TA, the scan voltage pulse is successively applied to the Y-electrodes Y2, Y4, . . . , Yn of the group of even-numbered lines, during which the address voltage pulse Va is applied to selected ones of the address electrodes A1-An. Thereafter, the address supplemental circuit 54 applies the supplemental pulse −Vxa1 to the X-electrodes X2, X4, . . . , Xn of the group of even-numbered lines, during which the address electrode driver circuits 46 apply the supplemental pulse Vaa′ to the address electrodes A1-Am the particular length of time after the beginning of the application of the supplemental pulse −Vxa1. After the supplemental pulses −Vxa1 and Vaa′ are applied, the address supplemental circuit 54 applies the supplemental pulse Vxa2 to the X-electrodes X2, X4, . . . , Xn of the group of even-numbered lines. However, the supplemental pulses −Vxa1, Vxa2 and Vaa′ during the second sub-address period TA2 may not necessarily be applied.

Then, during the sustain period TS, the sustain voltage pulse is applied to the display electrodes (X1, Y1)-(Xn, Yn). The remaining operations of the X-electrode driver device 500, Y-electrode driver device 700 and address driver circuit 42 are similar to those described with reference to FIGS. 11A-11E.

As illustrated in FIG. 12F, in the address period TA, for each of the group of odd-numbered display electrode lines (X1, Y1)-(Xn−1, Yn−1) and the group of even-numbered display electrode lines (X2, Y2)-(Xn, Yn), the application of the supplemental pulse −Vxa1 to the X-electrodes of the cells in which address discharge has occurred is first begun to thereby cause the first discharge, and, slightly after that, the application of the supplemental pulse Vaa′ to the address electrodes is begun to thereby cause the second discharge. By thus dividing the opposite discharge caused by the application of the supplemental pulses −Vxa1 and Vaa of FIGS. 11A-11E into the two smaller discharges as illustrated in FIGS. 12A-12E, an excessive voltage may be prevented from being applied all at once between the Xj electrode and Ai electrode of a cell with normal wall charges, which, in turn, can prevent self-erase discharge between the electrodes.

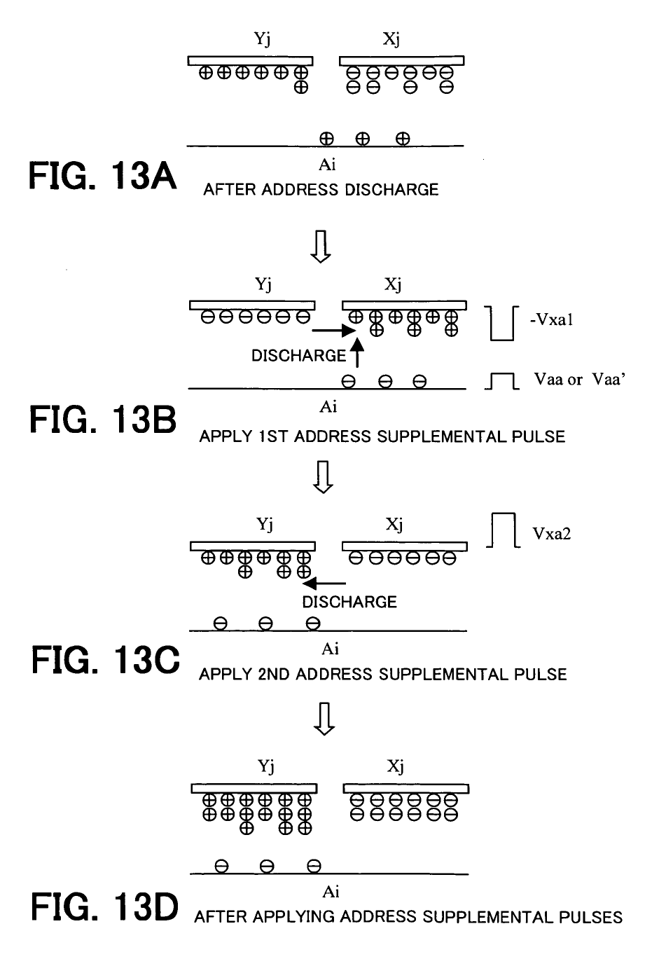

FIGS. 13A-13D illustrate an example of changing states of wall charges on the address electrode Ai, the sustain electrode Xj and the scan electrode Yj of a cell, after the address discharge which forms an insufficient amount of negative charge on the sustain electrode Xj and an insufficient amount of positive charge on the scan electrode Yj, during the subsequent address supplemental discharge, and after the address supplemental discharge, according to the driving sequence illustrated in FIGS. 11 and 12.

FIG. 13A illustrates the states of the wall charges on the address electrode Ai, the sustain electrode Xj and the scan electrode Yj after the application of the scan voltage pulse −Vy to Y-electrodes (Y1, Y3, . . . , Yn−1) or (Y2, Y4, . . . , Yn) of the group of odd-numbered or even-numbered lines. These states of the wall charges are similar to the ones illustrated in FIG. 7C.

As illustrated in FIG. 13B, the application of the supplemental voltage pulse −Vxa1 to the sustain electrode Xj and the application of the address supplemental voltage pulse Vaa or Vaa′ to the address electrode Ai cause an opposite discharge to be generated between the sustain electrode Xj and the address electrode Ai, and cause a surface discharge to be generated between the sustain electrode Xj and the scan electrode Yj. This provides a sufficient amount of positive wall charge on the sustain electrode Xj, a sufficient amount of negative wall charge on the scan electrode Yj, and a small amount of negative wall charge on the address electrode Ai.

After that, as illustrated in FIG. 13C, a surface discharge is generated between the sustain electrode Xj and the scan electrode Yj by applying the supplemental voltage pulse Vxa2 to the sustain electrode Xj, whereby, as illustrated in FIG. 13D, a sufficient amount of negative wall charge is formed on the sustain electrode Xj, with a sufficient amount of positive wall charge formed on the scan electrode Yj. These states of wall charges are similar to the ones illustrated in FIG. 6C.

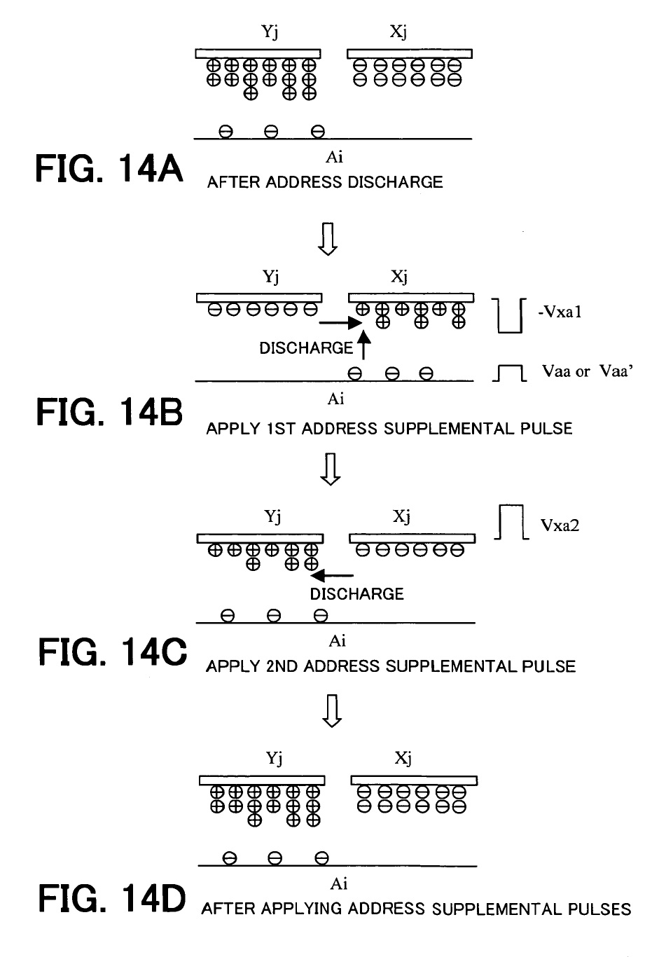

FIGS. 14A-14D illustrate an example of changing states of wall charges on the address electrode Ai, the sustain electrode Xj and the scan electrode Yj of a cell, after the address discharge which provides a sufficient amount of negative charge on the sustain electrode Xj and a sufficient amount of positive charge on the scan electrode Yj, during the subsequent address supplemental discharge, and after the address supplemental discharge, according to the driving sequence illustrated in FIGS. 11 and 12.

FIG. 14A illustrates the states of the wall charges on the address electrode Ai, the sustain electrode Xj and the scan electrode Yj after the application of the scan voltage pulse −Vy to the Y-electrodes (Y1, Y3, . . . , Yn−1) or (Y2, Y4, . . . , Yn) of the group of odd-numbered or even-numbered lines. These states of the wall charges are similar to the ones illustrated in FIG. 6C.

As illustrated in FIG. 14B, the application of the supplemental voltage pulse −Vxa1 to the sustain electrode Xj and the application of the address supplemental voltage pulse Vaa or Vaa′ to the address electrode Ai cause an opposite discharge to be generated between the sustain electrode Xj and the address electrode Ai, and cause a surface discharge to be generated between the sustain electrode Xj and the scan electrode Yj. This provides a sufficient amount of positive wall charge on the sustain electrode Xj, a sufficient amount of negative wall charge on the scan electrode Yj, and a small amount of negative wall charge on the address electrode Ai. These states of the wall charges are similar to the ones illustrated in FIG. 13B.

After that, as illustrated in FIG. 14C, a surface discharge is generated between the sustain electrode Xj and the scan electrode Yj by applying the supplemental voltage pulse Vxa2 to the sustain electrode Xj, whereby, as illustrated in FIG. 14D, a sufficient amount of negative wall charge is formed on the sustain electrode Xj with a sufficient amount of positive wall charge formed on the scan electrode Yj. These states of the wall charges are similar to the ones illustrated in FIGS. 14A and 6C.

When the above-described supplemental voltage pulses −Vxa1, Vxa2 and Vaa or Vaa′ are applied to the address electrode Ai and the sustain electrode Xj of a cell in which an unsuccessful address discharge has occurred or an address discharge has not occurred, discharges as illustrated in FIGS. 13A-13C or FIGS. 14A-14C do not occur, and the wall charges on the electrodes Ai, Xj and Yj remain in the states illustrated in FIG. 8B.

In the described embodiment, the address period TA is divided into two sub-address periods, with the display electrodes divided correspondingly into two, namely, groups of odd-numbered and even-numbered lines. However, the address period may be divided into three or more sub-address periods, with the display electrodes correspondingly divided into three or more groups based on modulo three or more (mod n≧3), with applying the supplemental pulse at the end of each sub-address period. However, the supplemental pulses −Vxa1, Vxa2 and Vaa or Vaa′ may not be applied in the last sub-address period of the address period.

The above-described embodiments are only typical examples, and their combination, modifications and variations are apparent to those skilled in the art. It should be noted that those skilled in the art can make various modifications to the above-described embodiments without departing from the principle of the invention and the accompanying claims.

What is claimed is:

1. A method of driving a display device of a plasma tube array type, the display device comprising: an array of plasma tubes, each plasma tube being filled with discharge gas, a plurality of pairs of display electrodes arranged on a front side of the array of plasma tubes and extending in parallel across the plasma tubes to define a plurality of display lines, and a plurality of address electrodes arranged on a rear side of the array of plasma tubes and extending along a length direction of the plasma tubes, the method comprising:
addressing, in a first address period, a first group of display lines of the plurality of display lines, and
addressing, in a second address period, a second group of remaining display lines of the plurality of display lines, wherein,
in the first address period, a scan pulse is applied sequentially to display electrodes, each being one display electrode of each display electrode pair in a first group of display electrode pairs of the plurality of display electrode pairs, the first group of display electrode pairs corresponding to the first group of display lines,
thereafter in the first address period, a first supplemental pulse of a same polarity as that of the scan pulse is applied to other display electrodes, each being the other display electrode of each display electrode pair in the first group of display electrode pairs, while a second supplemental pulse of a polarity opposite to that of the first supplemental pulse is applied to the plurality of address electrodes, and
thereafter in the first address period before the second address period, a third supplemental pulse of a polarity opposite to that of the first supplemental pulse is applied to the other display electrode of each display electrode pair in the first group of display electrode pairs.

2. The method of driving a display device according to claim 1, wherein the first group of display lines correspond to odd-numbered display lines of the plurality of display lines, and the second group of display lines correspond to even-numbered display lines of the plurality of display lines.

3. A method of driving a display device, the display device comprising a plurality of gas discharge tubes arranged side by side, each including a phosphor layer formed therewithin and being filled with discharge gas, a first plurality of pairs of display electrodes arranged on a display screen side of the plurality of gas discharge tubes, and a plurality of signal electrodes arranged on a rear side of the plurality of gas discharge tubes, the first plurality of pairs of display electrodes including a second plurality of pairs of display electrodes and a third plurality of pairs of display electrodes, the method comprising:
applying an address pulse for a corresponding display electrode pair of the second plurality of pairs of display electrodes to selected signal electrodes of the plurality of signal electrodes and a scan pulse to one display electrode of each display electrode pair in the second plurality of pairs of display electrodes, during a first sub-period of an address period;
applying, during the first sub-period of the address period, a first supplemental pulse of a same polarity as that of the scan pulse to the other display electrode of each display electrode pair in the second plurality of pairs of display electrodes after the application of the scan pulse to the one display electrode of each display electrode pair in the second plurality of pairs of display electrodes, while applying a second supplemental pulse of a same polarity as that of the address pulse to the plurality of signal electrodes, and, thereafter, applying a third supplemental pulse of a same polarity as that of a sustain pulse to the other display electrode of each display electrode pair in the second plurality of pairs of display electrodes;
applying an address pulse for a corresponding display electrode pair of the third plurality of pairs of display electrodes to selected signal electrodes of the plurality of signal electrodes and a scan pulse to one display electrode of each display electrode pair in the third plurality of pairs of display electrodes, during a second sub-period of the address period; and
applying a sustain pulse to the other display electrode of each display electrode pair in the second and third pluralities of pairs of display electrodes.

4. The method according to claim 3, wherein the first and second supplemental pulses are applied substantially simultaneously.

5. The method according to claim 3, wherein the application of the second supplemental pulse is started after starting the application of the first supplemental pulse.

6. The method according to claim 3, wherein the first supplemental pulse has substantially the same height as the scan pulse, and the third supplemental pulse has substantially the same height as the sustain pulse.

7. The method according to claim 3, wherein the first and third supplemental pulses have substantially the same width as the sustain pulse.

8. The method according to claim 3 further comprising:
applying, during the second sub-period of the address period, the first supplemental pulse to the other display electrode of each display electrode pair in the third plurality of pairs of display electrodes after the application of the scan pulse to the one display electrode of each display electrode pair in the third plurality of pairs of display electrodes, while applying the second supplemental pulse to the plurality of signal electrodes, and, thereafter, applying the third supplemental pulse to the other display electrode of each display electrode pair in the third plurality of pairs of display electrodes.

9. A display device comprising:
a plurality of gas discharge tubes arranged side by side, each including a phosphor layer formed therewithin and being filled with discharge gas;
a first plurality of pairs of display electrodes arranged on a display screen side of the plurality of gas discharge tubes;
a plurality of signal electrodes arranged on a rear side of the plurality of gas discharge tubes;
the first plurality of pairs of display electrodes including a second plurality of pairs of display electrodes and a third plurality of pairs of display electrodes;
an address driver circuit for applying an address pulse for a corresponding display electrode pair of the second plurality of pairs of display electrodes to selected signal electrodes of the plurality of signal electrodes during a first sub-period of an address period, and applying an address pulse for a corresponding display electrode pair of the third plurality of pairs of display electrodes to selected signal electrodes of the plurality of signal electrodes during a second sub-period of the address period;
a scan driver circuit for applying a scan pulse to one display electrode of each display electrode pair in the second plurality of pairs of display electrodes during the first sub-period of the address period, and applying a scan pulse to one display electrode of each display electrode pair in the third plurality of pairs of display electrodes during the second sub-period of the address period; and
a sustain driver circuit for applying a sustain pulse to the other display electrode of each display electrode pair in the second and third pluralities of pairs of display electrodes during a sustain period subsequent to the address period;
during the first sub-period of the address period, after the application of the scan pulse to the one display electrode of each display electrode pair in the second plurality of pairs of display electrodes, the sustain driver circuit applying a first supplemental pulse of a same polarity as that of the scan pulse to the other display electrode of each display electrode pair in the second plurality of pairs of display electrodes, while the address driver circuit applies a second supplemental pulse of a same polarity as that of the address pulse to the plurality of signal electrodes, and, thereafter, the sustain driver circuit applying a third supplemental pulse of a same polarity as that of the sustain pulse to the other display electrode of each display electrode pair in the second plurality of pairs of display electrodes.

10. The display device according to claim 9, wherein the first and second supplemental pulses are applied substantially simultaneously.

11. The display device according to claim 9, wherein the application of the second supplemental pulse is started after starting the application of the first supplemental pulse.

12. The display device according to claim 9, wherein the first supplemental pulse has substantially the same height as the scan pulse; and the third supplemental pulse has substantially the same height as the sustain pulse.

13. The display device according to claim 9, wherein the first and third supplemental pulses have substantially the same width as the sustain pulse.

14. The display device according to claim 9, wherein, during the second sub-period of the address period, after the application of the scan pulse to the one display electrode of each display electrode pair in the third plurality of pairs of display electrodes, the sustain driver circuit applies a first supplemental pulse of a same polarity as that of the scan pulse to the other display electrode of each display electrode pair in the third plurality of pairs of display electrodes, while the address driver circuit applies the second supplemental pulse to the plurality of signal electrodes, and, thereafter, the sustain driver circuit applies the third supplemental pulse to the other display electrode of each display electrode pair in the third plurality of pairs of display electrodes.
